(19) United States
(12) Patent Application Publication
(10) Pub. No.: US 2012/0047236 A1
(43) Pub. Date: Feb. 23, 2012

(54) METHOD AND APPARATUS FOR FILE TRANSFER

(75) Inventors: Dong-Yoon SHIN, Seoul (KR); Jin-Young KWAK, Seoul (KR)

(73) Assignee: EPVOL CO., LTD., Seoul (KR)

(21) Appl. No.: 13/215,736

(22) Filed: Aug. 23, 2011

(30) Foreign Application Priority Data
Aug. 23, 2010 (KR) 10-2010-0081465
Aug. 9, 2011 (KR) 10-2011-0079092

(51) Int. Cl. G06F 15/16

(52) U.S. Cl. 709/219

(57) ABSTRACT

A file transfer method is provided. The file transfer method includes receiving, by a web server, connection information from a router; transferring, by the web server, connection information received from the router to the electronic device according to a mapping table in response to a connection information request signal output from an electronic device; transferring, by the electronic device, a connection request signal to the router by using the connection information; determining, by the router, if the connection information is valid according to the connection request signal; transferring, by the electronic device, a file transfer request signal, which requests a transfer of at least one of files stored in an external storage device connected to the router, to the router when the router and the electronic device are connected to each other; and fetching, by the router, one of files stored in the external storage device in response to the file transfer request signal and transferring it to the electronic device.

### CROSS-REFERENCE TO RELATED APPLICATIONS

This application claims priority under 35 U.S.C. §119 from Korean Patent Application Nos. 10-2010-0081465 filed on Aug. 23, 2010 and 10-2011-0079092 filed on Aug. 9, 2011, the entire contents of which applications are hereby incorporated by reference.

### BACKGROUND

Embodiments of the present inventive concept relate to a method for file transfer, and more particularly, to a file transfer method which may transfer files, by using a router, stored in an external storage device connected to the router to a user or a third party and apparatuses performing the method.

As a multi-media era is accelerated and contents are getting to be in a large capacity, demands for various kinds of contents and large amounts of information sharing have expanded. Currently a community service provided by a current internet portal has limited capacity to upload files because of an enormous cost of server. Accordingly, users had to use Web hard services to share large amounts of the information. The web hard service may secure a storage space large enough to upload the large amounts of information the users have requested; however, the users have to pay an amount in proportion to the capacity they requested.

### SUMMARY OF THE DISCLOSURE

The present general inventive concept provides a file transfer method, by using a router, transferring files stored in an external storage device connected to the router to a user or a third party and apparatuses performing the method.

Another general inventive concept provides a file transfer method, in which a web server collects a variable IP address of a router in real time and renews itself with the most up to date connection information, so users can transmit and receive files to and from the router and apparatuses performing the method.

An embodiment of the present invention is directed to a router, including a connection module enabling data communication with an external storage device; and a file transfer module, transferring or receiving at least one of files between the external storage device and the electronic device, by using the connection module according to a file request signal of an electronic device.

According to embodiments, the file transfer module transfers connection information to a web server, every time a certain time passes, the external storage device is connected to the router, the IP address of the router changes, or the router turns on. Here, the connection information is an ID, a password and an IP address of the file transfer module. The file transfer module determines if the connection information is valid in response to a connection request signal output from the electronic device by using the connection information.

An embodiment of the present invention is directed to a web server, including a connection information reception module receiving connection information transferred from a router; a data base storing the connection information; and a connection information transfer module transferring, the connection information stored in the data base to a first electronic device in response to a connection information request signal of the first electronic device. Here, the connection information is an ID, a password and an IP address of the router.

According to embodiments, the web server further includes a user information reception module receiving an ID and password of the first electronic device and an ID and password of the router from the first electronic device connected to the web page which the web server provides; and a mapping table generation module generating a mapping table by mapping the ID and password of the first electronic device received from the user information reception module with the connection information received from the router.

According to embodiments, the web server further includes a transfer control module controlling at least one of files stored in an external storage device connected to the router to be transmitted to a second electronic device and controlling at least one of files to be received from a second electronic device and to be stored in an external storage device connected to the router in response to the transfer control request signal received from the first electronic device; and a file link module receiving the location and name of a file stored in the external storage device in response to the transfer control signal output from the transfer control module and linking the location and name of the file with the ID and password of the second electronic device connected to the web page which the web server provides.

An embodiment of the present invention is directed to a file transfer system, including a router connecting to an external storage device and communicating (by transmitting or receiving) at least one of files stored in the external storage device; a first electronic device for communicating the router with a file; and a web server. The web server includes a connection information reception module receiving connection information transferred from the router; a data base storing connection information received from the connection information reception module; and a connection information transfer module transferring connection information stored in the data base to the first electronic device in response to the connection information request signal of the first electronic device. Here, the connection information is an ID, a password and an IP address of the router.

An embodiment of the present invention is directed to a web server, including a user information reception module receiving an ID and a password of a first electronic device and an ID and a password of the router from the first electronic device connected to a web page which the web server provides; and a mapping table generation module generating a mapping table by mapping an ID and password of the first electronic device received from the user information reception module with the connection information received from the router.

An embodiment of the present invention is directed to a web server including a transfer control module controlling at least one of files, stored in an external storage device connected to the router to be transferred to a second electronic device and controlling at least one of files to be received from a second electronic device and to be stored in an external storage device connected to the router in response to a transfer control request signal received from the first electronic device; and a file link module receiving the location and name of a file stored in the external storage device in response to the transfer control signal output from the transfer control module and linking the location and name of the file with the ID and password of the second electronic device connected to the web page which the web server provides.

An embodiment of the present invention is directed to a file transfer method, including (A) receiving, by a web server, connection information including an ID, a password and IP address of an electronic device from a router; (B) transferring, by the web server, according to a mapping table in response to a connection information request signal output from an electronic device, connection information received from the router to the electronic device; (C) transferring, by the electronic device, a connection request signal to the router by using the connection information; (D) determining, by the router, if the connection information is valid according to the connection request signal; (E) transferring, by the electronic device, a file transfer request signal requesting transfer (by uploading or downloading) of at least one of files stored in an external storage device connected to the router, to the router when the router and the electronic device are connected to each other due to the connection information determined as valid; and (F) storing, by the router, a file transferred from an electronic device to the external storing device if the file transfer request signal request is upload, and transferring at least one of files stored in the external storage device, by fetching, to the electronic device, if the file transfer request signal is download.

Another example embodiment of the present invention is directed to a file transfer method, including (A) receiving, by the web server, a transfer control request signal including an ID and password of a second electronic device connected to a web page which the web server provides from the first electronic device so as to transfer, by the router, least one of files stored in an external storage device connected to the router, to a second electronic device by the request of the first electronic device; (B) transferring, by the web server, the transfer control signal request to the router and receiving a connection information including the location and name of the file stored in the external storage device from the router; (C) storing, by the web server, the link value by linking the location and name of the received file with the ID and password of the second electronic device; (D) transferring, by the web server, the location and name of the file including a router connection address in response to the file transfer request signal of the second electronic device connected by the link value to the second electronic device.

In one general aspect, a web server provides users with files transmitting and receiving service from and to a router so that the users can transmit and receive files stored in an external storage device connected to the router.

In another aspect, a web server provides users linked to a web server with accurate connection information of a router, after collecting real time variable IP address of a router, so that success rate of a file transfer can increase.

### BRIEF DESCRIPTION OF THE DRAWINGS

Other aspects of the exemplary embodiments will become apparent from the following descriptions of the embodiments with reference to the accompanying drawings in which:

FIG. 1 shows a schematic block diagram of a file transfer system according to an example embodiment of the present invention;

FIG. 2 shows a schematic block diagram of a router illustrated in FIG. 1;

FIG. 3 shows a schematic block diagram of a web server illustrated in FIG. 1;

FIG. 4 shows a data flow of the file transfer system illustrated in FIG. 1;

FIG. 5 shows a schematic block diagram of a file transfer system according to another example embodiment of the present invention;

FIG. 6 shows a schematic block diagram of a web server illustrated in FIG. 5;

FIG. 7 shows a schematic block diagram of the file transfer system illustrated in FIG. 5; and

FIG. 8 shows a schematic block diagram of a file transfer system according to still another example embodiment of the present invention.

### DETAILED DESCRIPTION OF THE DISCLOSURE

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

For the purposes of promoting an understanding of the principles of the inventive concept, reference will now be made to the embodiment illustrated in the drawings and specific language will be used to describe the same. It will nevertheless be understood that no limitation of the scope of the inventive concept is thereby intended, such alterations and further modifications in the illustrated inventive concept, and such further applications of the principles of the inventive concept as illustrated therein being contemplated as would normally occur to one skilled in the art to which the inventive concept relates.

The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another.

If any component is mentioned as being “connected” to or “contacting” another component, the component may be directly connected to or directly contact another component, but it should be understood that any further component can be present between them. Meanwhile, if it is mentioned that any component is “directly connected to” or “directly contacts” another component, it should be understood that any further component is not present between them. Other expressions relating to relationships among components, for example “between”, “just between”, “directly adjacent to”, or the like should be interpreted in the same way.

The terminology used herein is for the purpose of describing just the particular embodiments and is not intended to be limiting of the present disclosure. As used herein, the singular forms “a”, “an” and “the” are intended to include the plural forms as well, unless the context clearly indicates otherwise. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms including technical and scientific terms used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein. Hereinafter, preferred embodiments of the present disclosure will be described in detail with reference to the accompanying drawings.

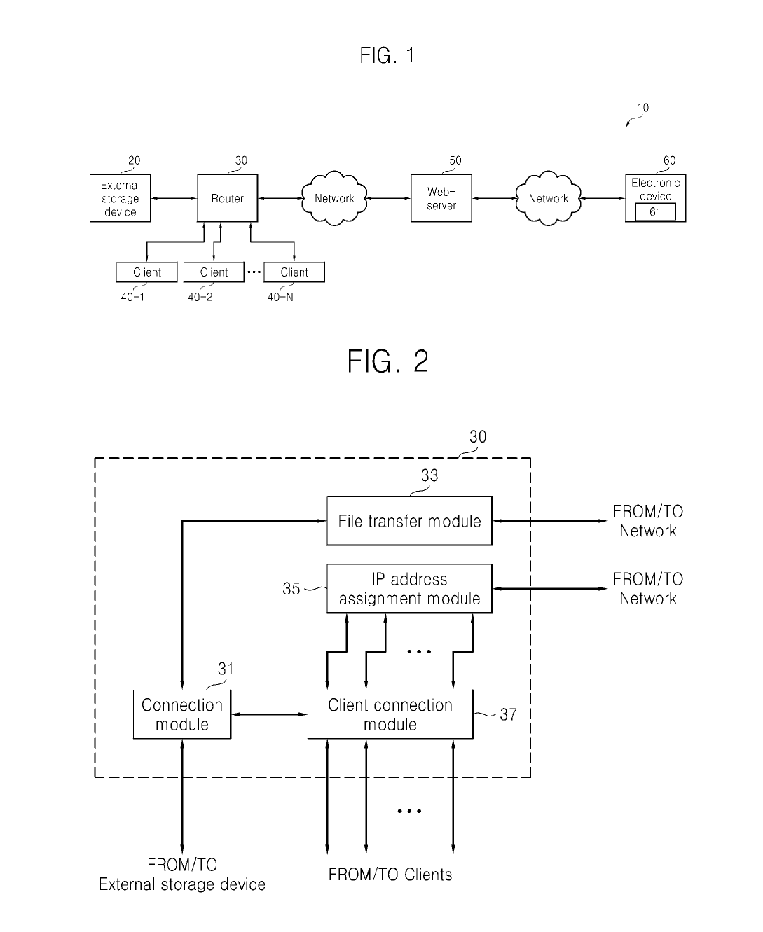

FIG. 1 shows a schematic block diagram of a file transfer system 10 according to an example embodiment of the present invention. Referring to FIG. 1, a file transfer system 10 includes an external storage device 20, a router 30, a web server 50 and an electronic device 60.

An external storage device 20 is a device for storing data such as multi-media contents. The external storage device 20 is additionally separated from a device consuming a high power such as a computer. For example the external storage device 20 may be one of a USB flash drive, compact flash (CF), a multi-media card (MMC), a xD-picture card, a Secure digital (SD) memory card, a memory stick, an external solid state drive (SSD), and an external hard disk drive (HDD). The data is stored in various types of files. The external storage device 20 is connected to a router 30.

FIG. 2 is a schematic block diagram of a router 30 illustrated in FIG. 1. Referring to FIGS. 1 and 2, the router 30 includes a connection module 31, a file transfer module 33, an IP address assignment module 35, and a client connection module 37.

A module of the present invention may mean a functional or structural combination of hardware for performing a technical concept according to embodiments of the present invention and software for driving the hardware. For example, the module may mean a logical or functional unit of a predetermined program code or a hardware resource for performing the program code. It may not always mean a physically connected program code or a kind of hardware.

A connection module 31 enables a data communication between the external storage device 20 and the router 30. That is, when the external storage device 20 is physically connected to the router 30, the connection module 31 may transfer files stored in the external storage device 20 to the router 30 or transfer files transferred from the router 30 to the external storage device 20.

A file transfer module 33 transfers one of files stored in the external storage device 20 to an electronic device 60 by using a connection module 31 according to a download file transfer request signal of the electronic device 60. Also, a file transfer module 33 receives a file from an electronic device 60 according to an upload file transfer request signal and by using a connection module 31 stores the file to an external storage device 20. That is, the router 30 performs a role of a file transfer protocol (FTP) server by including the file transfer module 33.

An IP address assignment module 35 receives a dynamic IP through an external network, and converts a received dynamic IP into a plurality of imaginary dynamic IPs. A client connection module 37 enables communication between a plurality of clients 40-1, 40-2, . . . , 40-N or communication between each of the plurality of clients 40-1, 40-2, . . . , 40-N and the external network according to the plurality of imaginary dynamic IPs. The external network means a wide area network (WAN), and each of the plurality of clients 40-1, 40-2, . . . , 40-N means an electronic device such as a computer or a laptop computer.

Each of the plurality of clients 40-1, 40-2, . . . , 40-N may receive files stored in the external storage device 20 by using the client connection module 37 and the connection module 31 or transfer its files to the external storage device 20. Each of the plurality of clients 40-1, 40-2, . . . , 40-N may communicate with the router 30 by wired network or by wireless network. A web server 50 provides a web page including a user interface for transferring a file to a user using an electronic device 60.

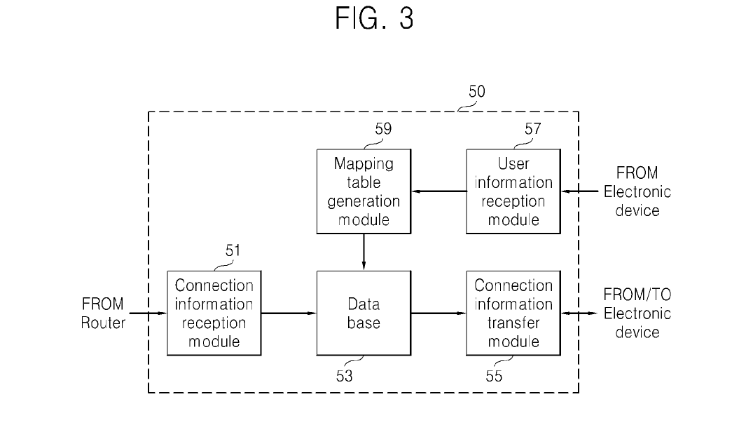

FIG. 3 shows a schematic block diagram of a web server 50 illustrated in FIG. 1. Referring to FIG. 1 or 3, the web server 50 includes a connection information reception module 51, a data base 53, a connection information transfer module 55, a user information reception module 57, and a mapping table generation module 59.

The connection information reception module 51 receives connection information from the file transfer module 33 of the router 30. The connection information includes an ID, a password and a dynamic IP address of the router 30. Here, the connection information reception module 51 receives a variably allocated IP address of the router 30 and therefore, the web server 50 can retain up to date IP address of a router.

The data base 53 stores connection information received from the connection information reception module 51. According to embodiments, the data base 53 may be embodied in an additional data base server. The connection information transfer module 55 transfers connection information stored in the data base 53 to the electronic device 60 in response to a connection information request signal of the electronic device 60. Here, the connection information transfer module 55 provides the electronic device 60 with the connection information that can directly access the router 30.

The user information reception module 57 receives an ID and password of an electronic device 60 connected to a web page provided by a web server 50, and an ID and a password of the router 30. The web server 50 provides a user interface so that a user using the electronic device 60 can transfer a file, and by using the web page, the ID and password of the electronic device 60 and the ID and password of the router 30 can be received from the user. Here, the ID and password of the electronic device 60 refers to the ID and password of a user using an electronic device 60 connected to a web page which the web server 50 provides (for example: log in ID/password).

A mapping table generation module 59 generates a mapping table by mapping an ID and password of an electronic device 60 received from the user information reception module 57 with the connection information including an ID, password and IP address of the router 30 received from the router 30 and stores a generated mapping table in the data base 53. Referring to FIG. 1, the electronic device 60 includes a file transfer request module 61.

The electronic device 60 may request a transfer of files stored in the external storage device 20 connected to the router 30 by using the file transfer request module 61. For example, the electronic device 60, as a terminal capable of internet communications, may be one of a computer, a smart phone, a laptop computer, a cellular phone, a tablet PC, a MP3 player, a smart TV and a navigation device. The electronic device 60 operates as a file transfer protocol (FTP) client by including the file transfer request module 61.

Hereinafter, an operation performed by the electronic device 60 should be understood as an operation performed by the file transfer request module 61 if there is no special explanation.

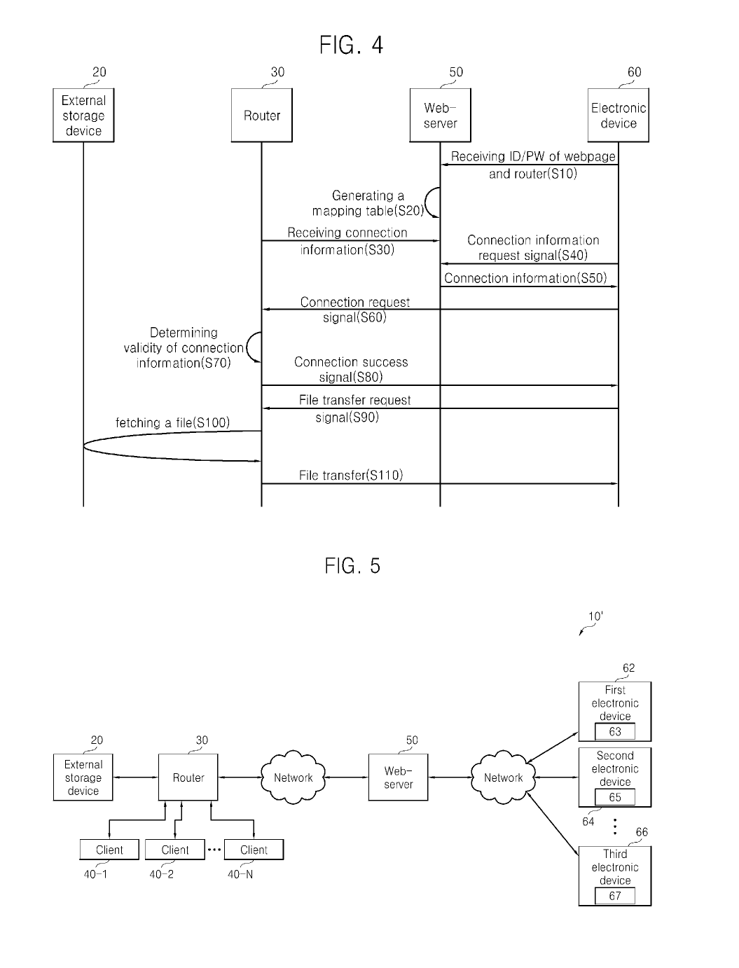

FIG. 4 shows a data flow of a file transfer system 10 of a file received from the router 30 to the electronic device 60 illustrated in FIG. 1. Referring to FIGS. 1 to 4, the web server 50 receives an ID and password of a user using an electronic device 60 connected to a web page which the web server 50 provides and an ID and a password of the router 30 (S10). Here, the user sets up an ID and password in advance along with a ID and password of the router used to transfer files. For users, using a plurality of routers 30, the user will need to set up an ID and password for each distinct router 30. The user may also set inherent user ID and password for every individual router 30.

Afterwards, the web server 50 generates a mapping table by mapping the received ID and password of an electronic device 60 with the received connection information including an ID, password and IP address of the router 30 respectively (S20). The web server 50 refers to the mapping table and provides corresponding router information to the user logging in, and then a particular router is selected by the user to receive requests to remit/receive a file. During the time the web server 50 is running, the web server 50 receives connection information from the router 30 (S30). Here, the connection information is an ID, a password, dynamic IP address of a router 30. The router 30 performs a role of a file transfer protocol (FTP) server by including the file transfer module 33. Accordingly, an ID, a password, and a dynamic IP address of the router 30 corresponds to an ID, a password, and a dynamic IP address of the file transfer module 33.

Additionally, the web server 50 receives connection information from a router 30 every time a certain time passes, an external storage device 20 is connected to a router 30, an IP address of a router changes, or a router 30 turns on. Therefore, because the web server 50 receives in real time the ever-changing IP address of a router 30 periodically or by event, the up to date IP address of a router 30 can always be saved. So, when the IP address of a router 30 becomes a variable, the web sever 50 provides, in regard to the file remit/receive request being requested by the electronic device 60, provides an accurate connection information based on the IP address of a router 30 that has been stored in real time. After the above steps (S10-S30), the user can request the above-mentioned file transfer (upload/download) after logging in to the web server 50.

A user of the electronic device 60 connects to a web page provided by a web server 50 and performs a file transfer request module 61 of an electronic device 60. Also, the user, by using an electronic device 60, transfers connection information request signal requesting connection information that can connect to a router 30 to a web server 50 (S40). The operation (e.g. log in) of connecting to the web page above is a user inputting his/her own ID and password to the web page.

Here, the user does not need to know each and every IP address of the router 30. That is, the web server 50 transfers connection information including a dynamic IP address of the router 30 by referencing mapping table to the file transfer request module 61 of the electronic device 60 in response to the connection information request signal, so the user only needs to know his/her ID and password.

The web server 50 transfers the connection information to the electronic device 60 by referencing the mapping table in response to a connection information request signal output from the electronic device 60 when the connection request signal of the user is received (S50).

When the connection information is received, the electronic device 60 transfers a connection request signal to the router 30 by using the connection information received for data communication with the router 30 (S60). The connection request signal includes the connection information.

When a connection occurs due to the connection information, the router 30 determines if the connection information is valid in response to the connection request signal transferred from the electronic device 60 (S70). In other words, the router 30 compares the connection information with ID, password and dynamic IP of the router 30 received from the electronic device 60 and determines whether the connection request is received from a person with a just right. If the request is determined as valid, the router 30 transmits the connection success signal to the electronic device 60 (S80).

The electronic device 60 selects at least one of files stored in the external storage device 20 connected to the router 30 and transmits a file transfer request signal to the router 30 (S90). Naturally, the electronic device 60 may select some of all the files stored in the external storage device 20.

When a file transfer request is made, the router 30 can transfer a file to the electronic device 60, by fetching, a selected file in response to a file transfer request signal received from the electronic device 60 (S110).

Meanwhile, the embodiments explain that the electronic device 60 downloads a file from the external storage device, but it is self-evident that the electronic device 60 may transfer a file to the external storage device 20 connected to the router 30.

FIG. 5 shows a schematic block diagram of a file transfer system 10′ according to another example embodiment of the present invention. Referring to FIG. 5, a file transfer system 10′ includes an external storage device 20, a router 30, a web server 50, and a plurality of electronic devices 62, 64, . . . , 66. An external storage device 20 and a router 30 have the same drawing numeral, operation and function as the external storage device 20 and the router 30 of FIG. 1, so that explanation thereof is omitted.

Each of the plurality of electronic devices 62, 64, . . . , 66 includes each of file transfer request modules 63, 65, . . . , 67. The plurality of electronic devices 62, 64, . . . , 66 have the same operation and function as the electronic device 60 of FIG. 1. The web server 50 allows a first electronic device 62 to select a file in the external storage device 20 connected to the router 30 and to transfer a selected file to a second electronic device 64. According to embodiments, the web server 50 may enable the selected file to be transferred as a lump to a plurality of electronic devices 64, . . . , 67.

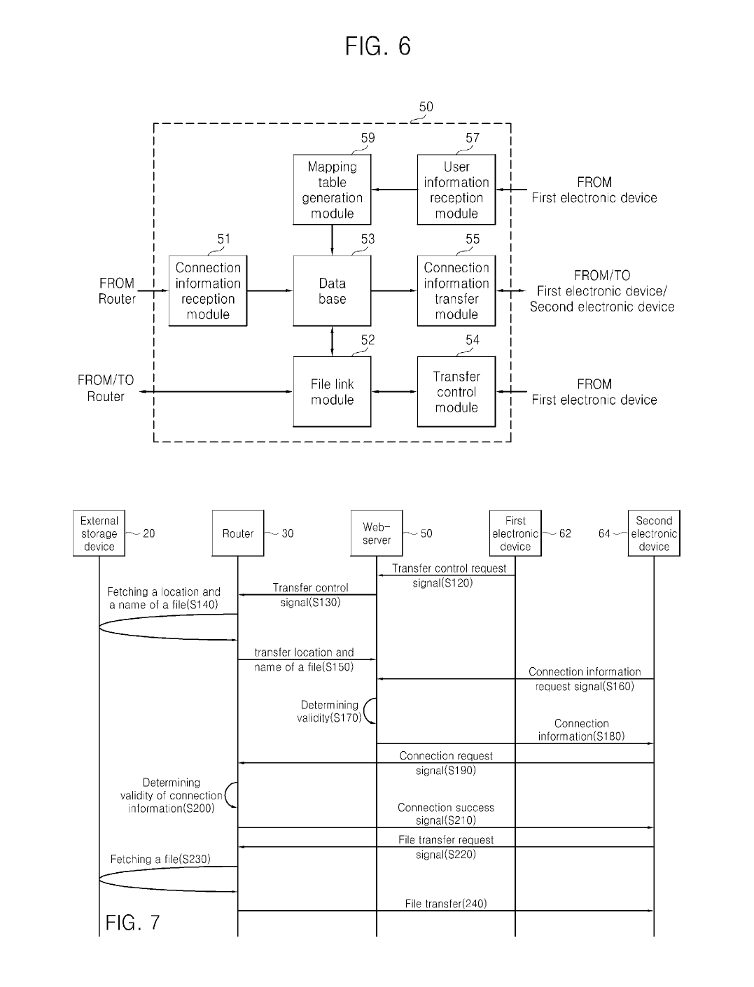

FIG. 6 shows a schematic block diagram of a web server illustrated in FIG. 5. Referring to FIGS. 5 and 6, the web server 50 includes a connection information reception module 51, a file link module 52, a data base 53, a transfer control module 54, a connection information transfer module 55, a user information reception module 57 and a mapping table generation module 59.

A connection information reception module 51, a data base 53, a connection information transfer module 55, a user information reception module 57 and a mapping table generation module 59 have the same drawing numeral, operation and function as the connection information reception module 51, the data base 53, the connection information transfer module 55, the user information reception module 57 and the mapping table generation module 59, so that explanation thereof is omitted.

The transfer control module 54 receives a control request signal from a first electronic device 62. The transfer control request signal is a signal which controls the first electronic device 62 to select at least one of files stored in the external storage device 20 connected to the router 30, and then controls the second electronic device 64 to access the router 30 and receive the file selected by the first electronic device 62.

Here, the user (first user) using the first electronic device 62 is different from the user (second user) using a second electronic device 64. Also, the control request signal includes an ID and password of a second electronic device that plans to connect to the web page provided by the web server 50. That is, the first user registers in advance the ID and password of the second user to the web server 50 so that the second user will be permitted to receive a file.

A file link module 52 transfers a transfer control signal, which controls the second electronic device 64 to access to a file selected by the first electronic device 62, to the router 30 in response to a transfer control request signal received from the transfer control module 54. The router 30 receives the transfer control signal and stores the file information and ID and password of a second user.

The file link module 52 receives the name and location of a file the first user plans to remit to the second user from the router 30 and generates a router connection address that corresponds to the ID and password of the second user transferred from the first electronic device 62. The file link module 52 stores the router connection address and a link value (link address to web server 50) that links to the router connection address to the data base 53.

When the second electronic device 64 attempts to access the file selected by the first electronic device 62, the transfer control module 54 receives the link value from the file link module 52 and determines whether the second electronic device 64 has an access right.

A connection information control module 55 transfers the newly updated router connection address stored in the data base in comparison with the link value in response to the connection information request signal received from the second electronic device 64 to the second electronic device 64. When the second electronic device 64 receives the router connection address, it connects to the router 30 by using the received connection information and then receives the file selected by the first user.

FIG. 7 shows a data flow where a file transfers from the first user to the second user by using a router 30 system illustrated in the file transfer system 10′ of FIG. 5.

Referring to FIGS. 5 to 7, it is assumed that operations of S10 to S80 of FIG. 4 are performed in a file transfer system of FIG. 7 and the first electronic device 62 is connected to the router 30 by performing operations of S10 to S80 of FIG. 4.

The first electronic device 62 selects at least one of files stored in the external storage device 20 connected to the router 30 and transfers a transfer control request signal, which controls the second electronic device 64 to access to the router 30 so that the selected file can be transferred to the web server 50 (S120).

Here, the transfer control request signal includes an ID and password of a second electronic device 64 that plans to connect to the web page provided by the web server 50. According to embodiments, the first electronic device 62 may select some of all of files stored the external storage device 20.

The web server 50 transfers a transfer control signal, which controls the second electronic device 64 to access the selected file, to the router 30 in response to the transfer control request signal (S130). Accordingly, since the web server 50 registers that the second user will connect to the router 30 in advance, the second electronic device 64 may access the router 30 only for the file selected by the first electronic device 62 and receive the file selected by the first user.

The router 30 fetches a location and a name of the selected file in response to the transfer control signal (S140), and transfers a location and a name of the selected file to the web server 50 (S150). At this time, the web server 50 generates a router connection address by using the location and name of the received file and the ID and password of the second electronic device 64 received from the first electronic device 62. Then, web server 50 stores the router connection address and a link value (link address to web server 50) that distinguishes the router connection address.

Here, when the link value is stored, the web server 50 or the first electronic device 62 notifies the link value to the second electronic device 64. For example, the web server 50 notifies the second user the link value by using a program of a web server 50 by the request of the first user. Or, the first electronic device 62 can receive the link value from the web server 50 and then by using ways such as email, SMS, and SNS notify the second user the link value.

Afterwards, the second electronic device 64 connects to the web server and transfers a connection information request signal, which requests the connection information of the router 30 where the selected file is located, using the link value that has been notified to the second electronic device 64, to the web server 50 (S160). At this time, the connection information request operation refers to the act of the user clicking the link value that distinguishes the router connection address stored in the web server 50.

The web server 50 determines if the connection information of the second user is valid in response to the connection information request signal received (S170). The web server 50 determines the validity when the received link value including the ID and password of the second user coincides with the stored ID and password of the second user.

When the web server 50 determines the request of the second electronic device 64 to be right, the router connection address corresponding to the link value is transferred to the second electronic device 64 (S180).

Here, every time the web server 50 receives the most up to date IP address from the router 30 in real time, then the router connection information renews to the received most up to date IP address. Therefore, the second user can connect to the router 30 by receiving router connection address that has been renewed to the most up to date IP address, even if by connecting to the web server 50 after the link value has been received and a fixed amount of time passes. For example, in the case the second user clicks on the link value a week after receiving the link value, the user can receive the file by using the router connection information reflecting the most up to date router IP address even if the address of the router 30 has been changed during the week.

The second electronic device 64 transfers a connection request signal to the router 30 by using the received router connection address (S190).

The router 30 determines if the transferred connection request signal is valid (S200) by comparing the connection information transferred from the second electronic device 64 and the connection information stored in the router 30, and in the case it is valid, transfers a transfer success signal to the second electronic device 64 (S210). Here, the router 30 determines the connection to be a success when the file information received from the second electronic device 64 and the ID and password of the second user coincides with stored information. Thus, the second electronic device 64 can access the router 30 by the selected file of the first electronic device 62.

The second electronic device 64 transfers a file transfer request signal, which requests a transfer of a file selected by the first electronic device 62 to the second electronic device 64, to the router 30 when the connection success signal is received (S220). The router 30 fetches a requested file in the external storage device 20 connected to the router 30 (S230) and transfers it to the second electronic device 64 (S240). According to embodiments, the first electronic device 62 may enable not only the second electronic device 64 but also a plurality of electronic devices to receive a file selected by the first electronic device 62.

The embodiments described a second electronic device 64 downloading files stored in the external storage device 20 by the request of the first electronic device 62. To substitute the downloading components with the uploading components, it is self evident that the second electronic device 64 can upload a file to the external storage device 30 connected to the router 30 by the request of the first electronic device 62.

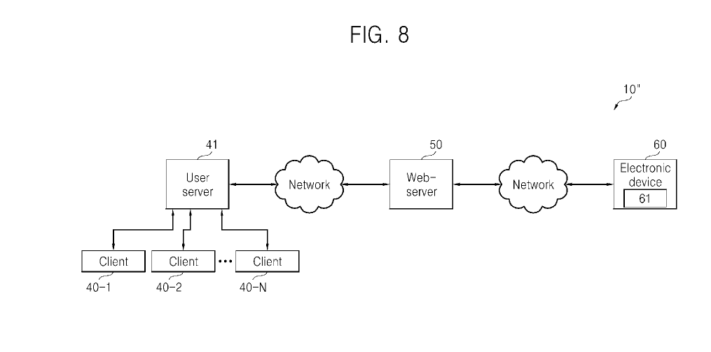

FIG. 8 shows a schematic block diagram of a file transfer system according to still another example embodiment of the present invention. Referring to FIG. 8, a file transfer system 10″ includes a user server 41, a web server 50 and an electronic device 60. A web server 50 ad an electronic device 60 have the same drawing numeral, operation and function as the web server 50 and the electronic device 60 of FIG. 1, so that explanation thereof is omitted.

A user server 41 refers to a device providing a service to a plurality of clients 40-1, 40-2, . . . , 40-N through a network. For example, the service refers to a file transfer or a content offer of a web page. The user server 41 includes modules of the router 30 illustrated in FIG. 2, an operation and a function of each module of FIG. 2 may be applicable to the user server 41 as explained in FIG. 2. For example, the user server 41 may be embodied in a PC or a laptop computer. The user server 41 is connected to a plurality of clients 40-1, 40-2, . . . , 40-N through a network. Here, the external storage device 20 may connect to user server 41 as a subsidiary device or substitute as a recording medium in a user server 41.

The user server 41 may transfer or receive at least one of files with the electronic device 60 and include the same module as the file transfer module 33 of FIG. 2. According to embodiments, user server 41 transfers a dynamic IP address or a static IP address of the user server 41 to the web server 50 as connection information.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

1. A router comprising:
a connection module enabling data communication with an external storage device; and
a file transfer module, transferring or receiving at least one of files between the external storage device and an electronic device, by using the connection module according to a file request signal of the electronic device.

2. The router of claim 1, wherein the file transfer module transfers connection information to a web server whenever a certain time passes, the external storage device is connected to the router, an IP address of the router changes, or the router gets turned on.

3. The router of claim 2, wherein the connection information is an ID, a password and an IP address of the file transfer module.

4. The router of claim 2, wherein the file transfer module determines if the connection information is valid in response to a connection request signal output from the electronic device by using the connection information.

5. A web server comprising:
a connection information reception module receiving connection information transferred from a router;
a data base storing the connection information; and
a connection information transfer module transferring the connection information stored in the data base to a first electronic device in response to a connection information request signal of the first electronic device.

6. The web server of claim 5, wherein the connection information is an ID, a password and an IP address of the router.

7. The web server of claim 5, further comprising:
a user information reception module receiving an ID and password of the first electronic device and an ID and password of the router from the first electronic device connected to a web page which the web server provides; and
a mapping table generation module generating a mapping table by mapping an ID and password of the first electronic device received from the user information reception module with the connection information received from the router.

8. The web server of claim 5, further comprising:
a transfer control module, controlling at least one of files stored in an external storage device connected to the router to be transmitted to a second electronic device and controlling at least one of files to be received from the second electronic device and to be stored in the external storage device connected to the router, in response to the transfer control request signal received from the first electronic device; and
a file link module receiving the location and name of a file stored in the external storage device in response to a transfer control signal output from the transfer control module and linking the location and name of the file with the ID and password of the second electronic device connected to a web page which the web server provides.

9. A file transfer system comprising:
a router connecting to an external storage device and communicating (by transmitting or receiving) at least one of files stored in the external storage device;
a first electronic device for communicating the router with a file; and
a web server,
wherein the web server comprises:
a connection information reception module receiving connection information from the router;
a data base storing the connection information received from the connection information reception module; and
a connection information transfer module transferring the connection information stored in the data base to the first electronic device in response to a connection information request signal of the first electronic device.

10. The file transfer system of claim 9, wherein the connection information is an ID, a password and an IP address of the router.

11. The file transfer system of claim 9, wherein the web server comprises:
a user information reception module receiving an ID and a password of the first electronic device and an ID and a password of the router from the first electronic device connected to a web page which the web server provides; and
a mapping table generation module generating a mapping table by mapping an ID and password of the first electronic device received from the user information reception module with the connection information received from the router

12. The web server of claim 9, further comprising:
a transfer control module controlling at least one of files, stored in the external storage device connected to the router to be transferred to the second electronic device and controlling at least one of files to be received from the second electronic device and to be stored in the external storage device connected to the router in response to a transfer control request signal received from the first electronic device; and a file link module receiving the location and name of a file stored in the external storage device in response to a transfer control signal output from the transfer control module and linking the location and name of the file with the ID and password of the second electronic device connected to a web page which the web server provides.

13. A file transfer method comprising:
(A) receiving, by a web server, connection information including an ID, a password and IP address of an electronic device from a router;
(B) transferring, by the web server, according to a mapping table in response to a connection information request signal output from the electronic device, the connection information received from the router to the electronic device;
(C) transferring, by the electronic device, a connection request signal to the router by using the connection information;
(D) determining, by the router, if the connection information is valid according to the connection request signal;
(E) transferring, by the electronic device, a file transfer request signal requesting transfer (by uploading or downloading) of at least one of files stored in an external storage device connected to the router, to the router when the router and the electronic device are connected to each other due to the connection information determined as valid; and
(F) storing, by the router, a file transferred from the electronic device to the external storing device if the file transfer request signal is upload, and transferring at least one of files stored in the external storage device, by fetching, to the electronic device, if the file transfer request signal is download.

14. The file transfer method of claim 13, after the step (A), further comprising:
receiving, by the web server, an ID and a password of a first electronic device and an ID and a password of the router from the first electronic device connected to a web page which the web server provides; and
generating and storing, by the web server, the mapping table by mapping the connection information in the step (A) with the ID and the password of the electronic device received from the electronic device.

15. A file transfer method comprising:
(A) receiving, by the web server, a transfer control request signal including an ID and password of a second electronic device connected to a web page which the web server provides from a first electronic device so as to transfer, by the router, at least one of files stored in an external storage device connected to the router, to the second electronic device by the request of the first electronic device
(B) transferring, by the web server, the transfer control signal request to the router and receiving connection information including the location and name of the file stored in the external storage device from the router;
(C) storing, by the web server, a link value by linking the location and name of the received file with the ID and password of the second electronic device; and
(D) transferring, by the web server, the location and name of the file including a router connection address in response to the file transfer request signal of the second electronic device connected by the link value to the second electronic device.

16. The file transfer method of claim 15, before the step (A), further comprising:
(A1) receiving, by the web server, connection information including ID, password and IP address of the router from the router,
(A2) transferring, by the web server, the connection information received from the router by referencing a mapping table in response to a connection information request signal output from the first electronic device to the first electronic device;
(A3) transferring, by the first electronic device, connection request signal by using the connection information, to the router; and
(A4) determining, by the router, if the connection information is valid according to the connection request signal.

17. The file transfer method of claim 16, wherein the step (A1) further comprises:
receiving, by the web server, ID and password of the first electronic device and ID and password of the router from the first electronic device connected to a web page which the web server provides
generating and storing, by the web server, the mapping table by mapping the connection information received from the router with the ID and password of the first electronic device received from the first electronic device.

18. The file transfer method of claim 15, wherein the step (D) further comprises:
(D1) receiving, the web server, the connection information from the router,
(D2) generating, the web server, a link value distinguishing a router connection address, and notifying, the web server or first electronic device, the link value to the second electronic device;
(D3) sending, the web server, a router connection address having real-time recent connection information of the router to the second electronic device according to the connection information of the step (D1), as a response to a connection information request signal received from the second electronic device connected by the link value;
(D4) transmitting, the second electronic device, the connection request signal to the router using the router connection address; and
(D5) determining, the router, if the router connection address is valid according to the connection request signal and transmitting the file requested by the first electronic device to the second electronic device if valid.

19. The file transfer method of any one of claims 15 to 18,
wherein the web server receives a transfer control request signal from the first electronic device so that the second electronic device uploads a file to the external storage device, and transmits a router connection address allowing a file to be uploaded to the second electronic device connected by the link value.

20. A file transfer system comprising:
a user server;
a first electronic device for receiving a file from the user server; and
a web server,
wherein the web server comprises:
a connection information reception module receiving connection information transferred from the user server;
a data base storing the connection information received from the connection information reception module; and
a connection information transfer module transferring the connection information stored in the data base to the first electronic device in response to a connection information request signal of the first electronic device,
wherein the user server may transfer at least one of files stored in the user server to the first electronic device.
